(19) United States
(12) Patent Application Publication
(10) Pub. No.: US 2011/0158562 A1
(43) Pub. Date: Jun. 30, 2011

(54) DEFLATABLE BAG WITH LATERALLY PERFORATED LINER AND NON-ADJACENT HUMIDITY BARRIER

(75) Inventors: Sylvain Desilets, Longueuil (CA); Claude Lemoyne, Saint-Jean-sur Richelieu (CA); Jonathan Le Sage, Shefford (CA); Paul Gélinas, Bromont (CA); Daniel Cartier, Sainte-Julie (CA); Daniel C. Engen, Doylestown, PA (US)

(73) Assignee: Emballage Rouville Inc., Marieville (CA)

(21) Appl. No.: 12/732,111

(22) Filed: Mar. 25, 2010

Related U.S. Application Data
(60) Provisional application No. 61/291,673, filed on Dec. 31, 2009.

(51) Int. Cl. B65D 33/01; B65D 30/08; B65G 57/02

(52) U.S. Cl. 383/101; 383/113; 414/802

(57) ABSTRACT

The present invention pertains to a multilayer bag for receiving a powder material. A tubular wall is provided to have, once the bag is filled with the powder material and stacked, stacking sections which face upward and downward and side sections which face laterally. The tubular wall has an inner plastic liner with vents along at least one of the side sections to allow stacking pressure to expel air through the vents. There is also a first paper layer contiguous with the inner plastic liner, then a humidity barrier layer non-adjacent with the inner plastic liner; and at least one outer paper layer. The placement of the vents and the non-adjacent humidity barrier facilitate expulsion of air via the vents during and after stacking and avoid inadvertent sealing melt bonding between the humidity barrier and the inner liner.

### CROSS-REFERENCE TO RELATED APPLICATIONS

This application claims priority to U.S. Provisional Application No. 61/291,673 filed Dec. 31, 2009. This application is hereby incorporated by reference in its entirety.

### BACKGROUND OF THE INVENTION

1. Field of the Invention

The present invention generally relates to the field of packaging and more particularly to deflatable bags for containing powder materials.

2. Description of the Related Art

The packaging of powder materials, such as powdered milk and the like, has challenges related to the transportation and storage of the packaged material while providing a humidity barrier to maintain the quality of the material. Multilayer paper bags are often provided with a polyethylene liner to provide a humidity barrier. Although plastic-lined bags can prevent humid air from entering the bag, they can also prevent sealed-in air from exiting, which can cause a number of problems. For instance, the sealed-in air itself can contaminate the powder material and the bags can also become turgid and therefore round and unstable for stacking and storage.

In order to mitigate this problem, some bags have been developed openings, vents and channels to attempt to allow air to escape from the interior of the bag. U.S. application Ser. No. 11/203,703 (Bannister et al.) and U.S. Pat. No. 6,986,605 (Allen et al.) describe packages with perforations and labyrinthine channels formed by the liner and other layers to allow release of air while attempting to reduce the penetration of humidity. Another issue with known bags is that when the bag is torn open it is desirable to ensure that no bits of the bag accidentally fall into the powder material.

Known bags still have disadvantages concerning deflation and expelling unwanted air especially in conjunction with efficient stacking for storage and also facility of end-use of the bags when opened.

### SUMMARY OF THE INVENTION

The present invention overcomes at least some of the disadvantages of known bags.

Accordingly, the present invention provides a multilayer bag having a sealable open end, a closed end, and a tubular wall between the ends defining a cavity for receiving a powder material. The tubular wall is sized and configured to have, once the bag is filled with the powder material and stacked, a first pair of opposed spaced-apart stacking sections which face upward and downward respectively and a second pair of opposed spaced-apart side sections which face laterally in opposite directions. The tubular wall comprises an inner plastic liner with vents sized and configured to be located along at least one of the lateral sections of the second pair to allow stacking pressure to expel air from inside the inner plastic liner through the vents. The bag also comprises various outer layers: a first paper layer contiguous with the inner plastic liner; a humidity barrier layer contiguous with the first paper layer and non-adjacent with the inner plastic liner; and at least one outer paper layer outside of the humidity barrier layer.

Due to the placement of the vents on the inner liner of the tubular wall, when the bags are stacked on top of each other, they engage and compress each other via the stacking sections, leaving the side sections to avoid compression or blockage and thus facilitate expulsion of air via the vents during and after stacking.

Once the bags are filled, sealed and stacked on top of each other, the lateral vent configuration allows rapid and reliable deflation under the weight of the stacked bags. This results in improved deflation rate and stacking stability, leading to increased safety and efficiency. In addition, the placement of the humidity barrier layer non-adjacently with respect to the inner liner avoids sealing them together and decreases the chance that, upon opening the bag, plastic pieces will detach and accidentally mix into the material.

Optionally, the vents comprise slits and are provided in a pattern for each side section, the pattern extending lengthwise along the inner plastic liner from the closed end to the open end. The pattern of the vents for each lateral section may comprise two linear rows and the vents are regularly spaced from each other. The vents may be regularly spaced away from each other by between about 2 inches to about 3 inches. Each of the vents may be sized between about 40 mil and about 60 mil. Each side section may have a center crease extending lengthwise and the vents are provided spaced away from the crease. The first and second pairs of sections preferably join to form corners and the vents are provided proximate the corners. Also preferably, the liner is attached to the first paper layer with adhesive at the open end. Optionally, the inner plastic liner is composed of low density polyethylene and the humidity barrier layer is composed of high density polyethylene. The vents may also be provided along the entire length of the inner plastic liner. The inner plastic liner may comprise a non-vented zone at each end of the bag and have diagonally sealed corners at the closed end of the bag. The bag may have a deflation rate of above about 30 cc/sec, preferably above about 40 cc/sec, and still preferably above about 60 cc/sec.

The invention also provides a method of stacking a plurality of bags, each bag being filled with the powder material and being defined as per at least one of the preferred embodiments of the bag herein described. The method comprises the steps of:

laying down a first set of the bags;

laying down a second set of the bags on top of the first set of bags; and

allowing sufficient time to elapse such that the first set of the bags deflates under stacking pressure to facilitate stable placement of a third set of bags on top of the second set of bags.

### BRIEF DESCRIPTION OF THE DRAWINGS

FIG. 1 is a plan partial-transparent view of an embodiment of the bag of the present invention.

FIG. 2 is a plan partial-transparent view of another embodiment of the bag of the present invention.

FIG. 3 is a plan partial-transparent view of yet another embodiment of the bag of the present invention.

FIG. 4 is a transverse cut view of an embodiment of the bag of the present invention.

FIG. 5 is a plan view of the closed end of a bag.

FIG. 6 is a side view schematic of an experimental setup for evaluating deflation of bags.

FIG. 7 is a top perspective exploded view, of an embodiment of the bag of the present invention.

FIG. 8 is a front view of a stack of bags according to an embodiment of the present invention.

FIGS. 9a and 9b are front and top views respectively of a stack of bags according to an embodiment of the present invention.

### DETAILED DESCRIPTION OF THE INVENTION

The embodiments of the bag of the present invention are preferably designed and used for packaging, transporting and storing powder material such as powdered milk and other products that can be damaged or contaminated by humidity. It should be understood that other types of materials may also be used in connection with some embodiments of the bag.

The manufacture of the multilayer bags of the present invention often involves the general process steps of rolling the paper and plastic layers, guiding the layers, merging the different layers to produce multi-walled flat sheets, imprinting the sheets when desired, forming the multi-walled sheets into tubes, and segmenting the tubes into discrete and individual bags. An example of such manufacturing system is the Strong-Robinette Model 5300-SU Tuber™.

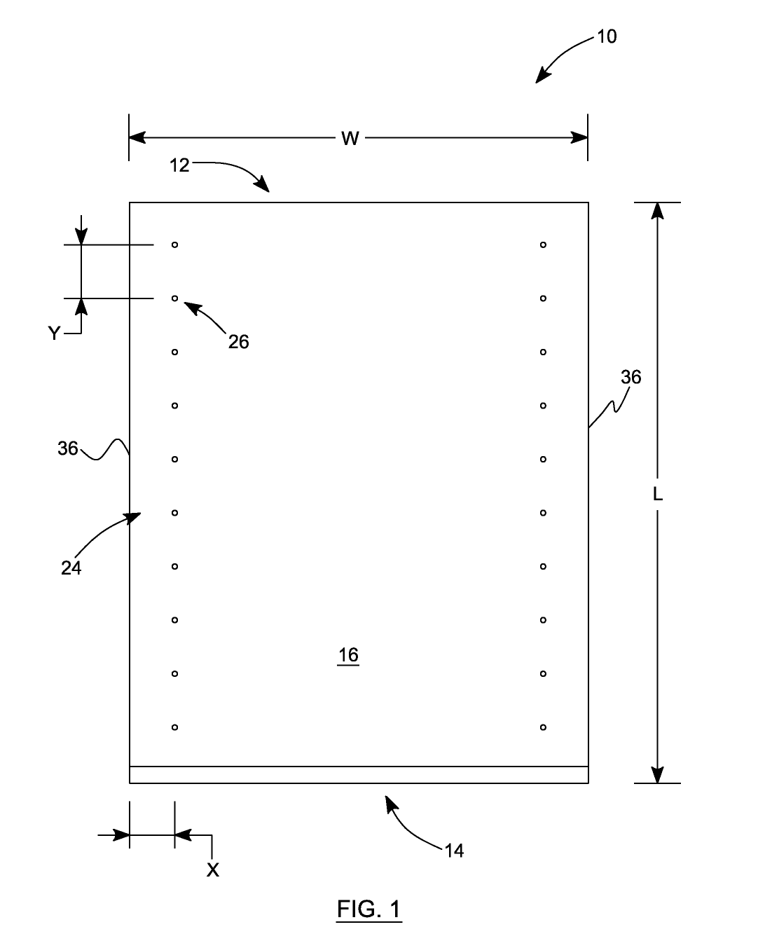

Referring now to FIGS. 1-3, each multilayer bag 10 has a sealable open end 12, a closed end 14, and a tubular wall 16 between the ends defining a cavity for receiving the powder material.

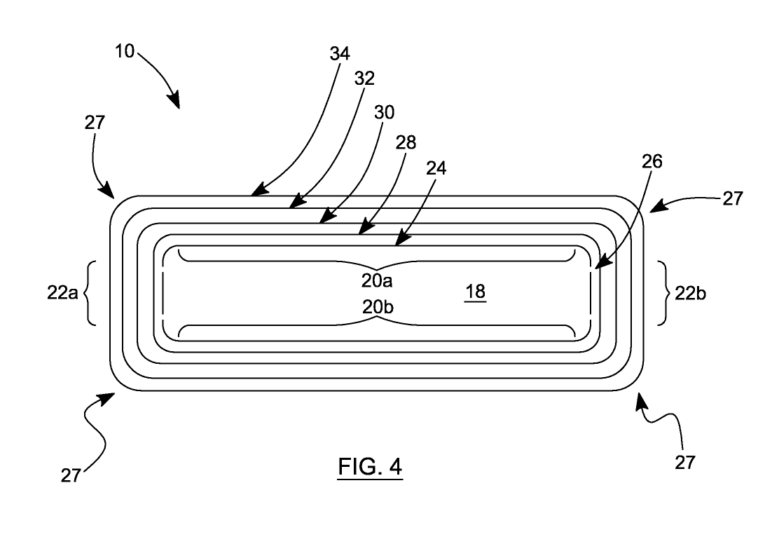

As best shown in FIG. 4, when the bag 10 is filled with the powder material 18, the tubular wall comprises a first pair of opposed spaced-apart walls 20a, 20b which face upward and downward respectively when the bag 10 is stacked, and a second pair of opposed spaced-apart walls 22a, 22b which face laterally in opposite directions.

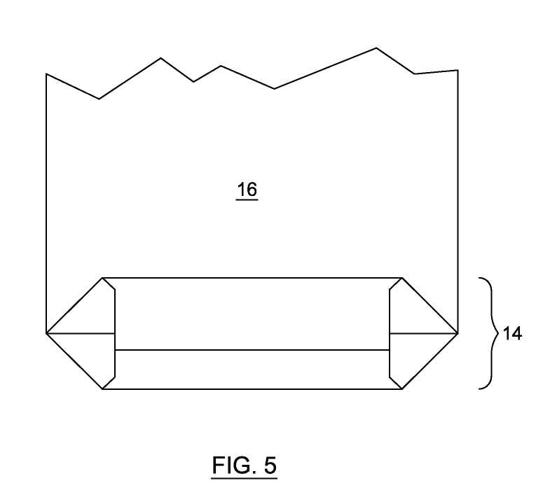

In this respect, it should be noted that a finished bag is usually flat until it is filled with material, upon which it will assume its in-use shape which depends mainly on the folding arrangement of the closed end. Since the closed end is usually rectangular shaped, as illustrated in FIG. 5, the tubular wall takes the form of the four walls 20a, 20b, 22a, 22b as illustrated in FIG. 4. The closed end may, however, have other forms while still enabling the bag 10 to have lateral walls 22a, 22b as well as upward and downward facing walls 20a, 20b. For some variants of the invention, the lateral walls 22a, 22b, may be formed as “gussets”, while in others they are formed on either side of a fold or crease in the tubular wall when filled with material and stacked.

Referring to FIGS. 1-4, the walls of the bag comprise various layers. There is an inner layer 24, made of a generally impermeable plastic material such as polyethylene. The inner layer 24 has vents 26, which may also be called holes, perforations, slits, slots, etc. The vents 26 are strategically provided on the inner layer such that, when the bag is filled with the powder material, the vents 26 are located along the lateral walls 22a, 22b. This placement of the vents 26 is particularly advantageous because, when the bags are filed and stacked on top of each other, they engage and press down on each other over the upward and downward facing walls 20a, 20b, thus freeing the vents to rapidly expel air and deflate the bags. Thus, the vent placement avoids that they are compressed and blocked into ineffectiveness when the bags are stacked and stored. The vents 26 are preferably provided in prefabricated flat plastic layer before introduction into the tubing manufacturing system. The vents 26 are also preferably arranged in a straight line along both opposed lateral sides of the plastic sheet layer 24 and also on both its front and back, which is done by simply puncturing through the folded layer to yield two vents per puncture. The vents 26 are preferably shaped so as to be “widthless” slits rather than two dimensional holes many forms are possible. The slit-shape allows air to exit the bag under stacking pressure, along with retention of the powder material, and also improves resistance to penetration of air from the outside under regular atmospheric pressure and diffusion. As mentioned above, it should thus be understood that the design of the closed end will affect the walls of bag and, consequently, the placement of the vents such that they are not located on the upward or downward walls 20a, 20b. It is also possible to provide only one row, as long as the bags are then stacked such that the row of vents is on any side 22a, 22b of the bag. The vents 26 are also preferably arranged proximate to the corners 27 between the walls, to further improve the speed and quantity of air expelled from the bag 10, since upon stacking the powder material will go to the bottom of the bag pushing air to the upper corners.

The vents 26 are preferably micro-sized, each being about 40 to 60 mil.

According to some embodiments of the present invention, the air exits the vents 26 of the inner layer 24 and is then released out of one or other of the opposed ends 12, 14, that is out of the fold of paper as illustrated in FIG. 5.

Referring to FIG. 4, the next layer is a first paper layer 28 that is contiguous with the inner liner 26. Preferably, the liner 26 is attached to the first paper layer 28 by a minimal amount of adhesive so as to be removable by simply tearing out the plastic liner 26. Still preferably, the adhesive is put only around the two opposed ends of the bag 10.

The next layer is a humidity barrier layer 30 that is contiguous with the first paper layer 28 and non-adjacent with the inner layer 26. Being non-adjacent ensures that the two plastic layers, the inner liner and the barrier layer, do not become sealed together which, in turn, prevents small, thin bits of the barrier layer from accidentally tearing off and falling into the material when the bag is opened to access the material. This barrier layer 30 is preferably made of a generally impermeable material such as polyethylene and may generally be considered a plastic film, being rather thin and structurally weak as compared to the inner liner 26. The barrier layer 30 preferably has no perforations. The barrier layer 30 may be provided with perforations (not illustrated), which may be over its entire surface when present. The perforations' size and density should be sufficient to impede humidity from re-entering the bag. For instance, the rows and columns of perforations may be evenly distributed over the barrier layer 30 to be about 1 inch away from adjacent perforations above, below and on either side. The vents 26 and the humidity barrier layer 30 thus cooperate to form a labyrinthine or tortuous path for air or humidity to enter the interior cavity of the bag, while improving the ability of the bag to expel sealed-in air by stacking pressure, not only improving stacking efficiency and safety but also storage longevity. The humidity barrier may be formed of a plurality of overlapping thin plastic strips, preferably extending in the direction between the two ends of the bag.

The next layer is a second paper layer 32 provided outside and contiguous with the barrier layer 30. Preferably, the barrier layer is connected to the second paper layer 32 using adhesive. The adhesive may be applied in a plurality of strips around the walls, each strip extending from end to end. The barrier layer 30 is preferably also adhered to the first paper layer only around each end using minimal adhesive.

The final layer in the preferred illustrated embodiment is an outer paper layer 34, which is contiguous with and adhered to the second paper layer 32. Preferably, the paper layers 28, 32, 34 are offset with respect to each other to facilitate the tubing manufacturing, as is well known in the art.

It should be noted that the dimensions of the bag, the walls, the layers, and the spacing of the vents may be adapted for particular applications and materials. Though some preferred dimensions will be discussed in connection with preferred embodiments, such dimensions may be altered while still retaining the inventive features of the invention.

Referring now to FIG. 1, in a first embodiment of the bag 10, the vents 26 are provided spaced inwardly of the lateral crease 36 by a distance X, which may be 25% the bottom 14 width±¼ inch. The vents 26 may be spaced away from each other by a regular interval Y, which may be 2½ inches±¼ inch. In this embodiment, the vents near the ends can be in the sealing part of the bag, that is where the plastic liner is heat-sealed. The length L and width W may be adapted according to the desired size of bag.

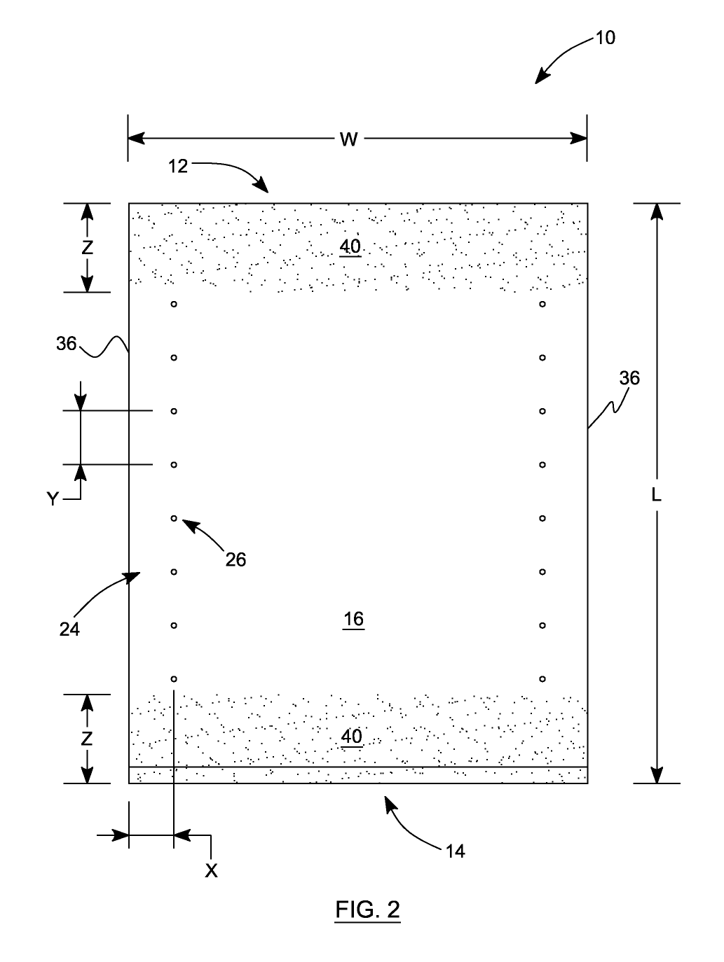

Referring to FIG. 2, in a second embodiment of the bag 10, the vents 26 are provided with similar X and Y, but there is also a non-vented zone 40, preferably are each end of the bag 10. The non-vented zone 40 may have a length Z of 4 inches±½ inch. The non-vented zones 40 limit air or humidity infiltration via the ends, and thus limits it to the middle of the bag 10. This may be advantageous when there is a risk or tendency of humidity infiltration at the ends.

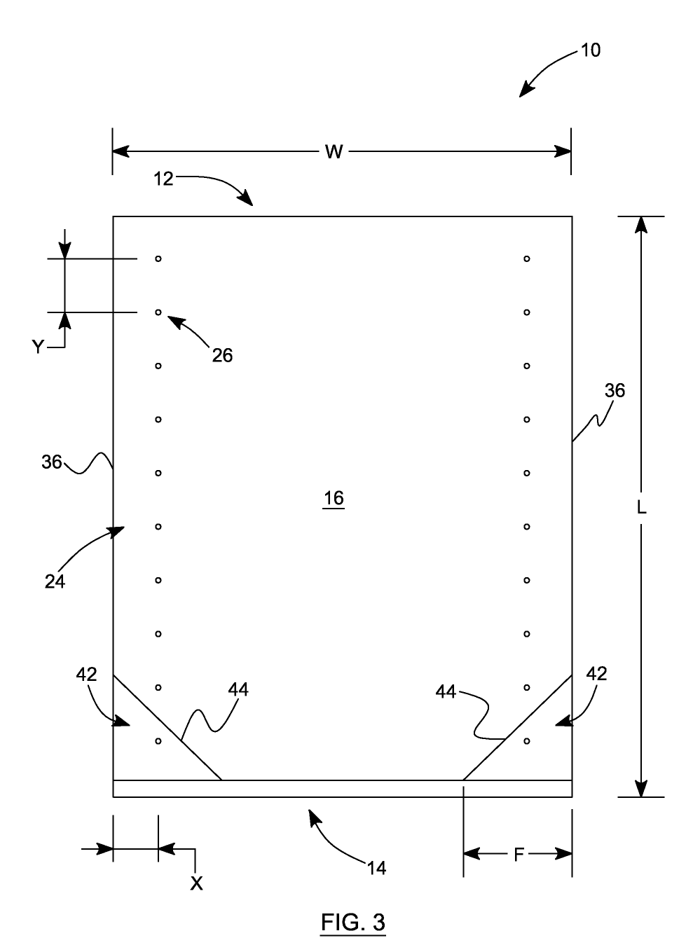

Referring to FIG. 3, in a third embodiment of the bag 10, which is similar to the first embodiment, there are diagonally sealed corners 42 at the closed end 14 of the bag 10 spaced from the later crease 36 by a distance of F which may be 3 inches±1 inch. Each corner 42 has a heat-sealed or adhesive-sealed joint 44, making the closed end have an inwardly tapered shape. Sealing off the corners 42 can alleviate problematic accumulation of air or humidity in those regions, which form the bottom of the bag during filing, while leaving sufficient vents 26 on the lateral walls to allow rapid deflation of the bags 10 upon stacking.

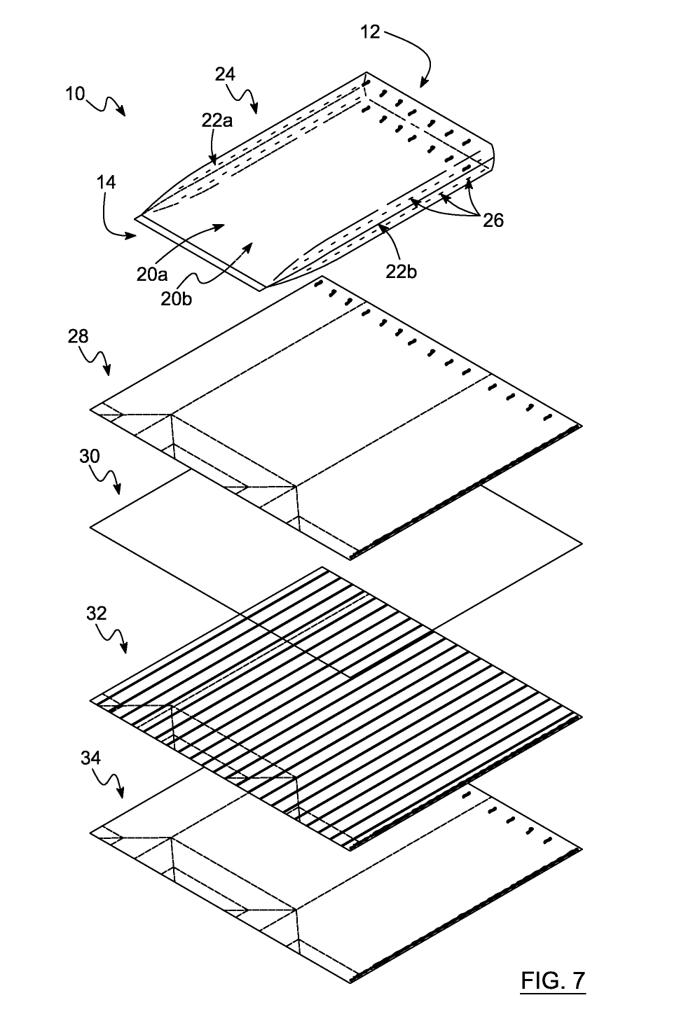

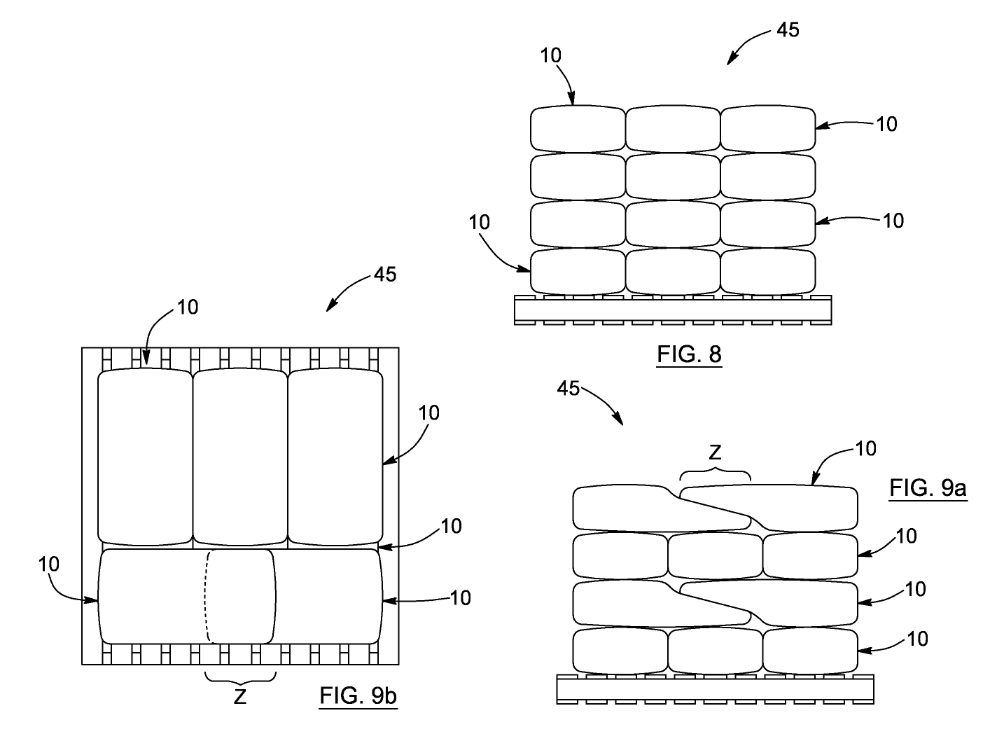

Referring to FIG. 8, the bags 10 can be stacked up to form a stacking arrangement 45. The stacking method is preferably performed in conjunction with the deflation rate of the bags 10, so that each subsequent set of bags 10 is laid down once the previous set of bags has caused the underlying set of bags to sufficiently deflate under stacking pressure to allow stable stacking.

Referring to FIGS. 9a and 9b, the bags 10 may alternatively be stacked to form a stacking arrangement 45 where each row of bags 10 comprises at least two partially overlapping bags. In one variant of this stacking arrangement, there are five bags per row, three of which are arranged side-by-side and two of which are arranged so that their sides span the aligned top ends of the three other bags and are placed so as to have an overlap region Z at their abutting ends. FIG. 9a shows a stacking arrangement 45 where this five-bag row configuration alternates every row and repeats every second row. This type of stacking can enable increased stability.

### Examples

Experiments were conducted to test the deflation performance of certain embodiments of the present invention during stacking.

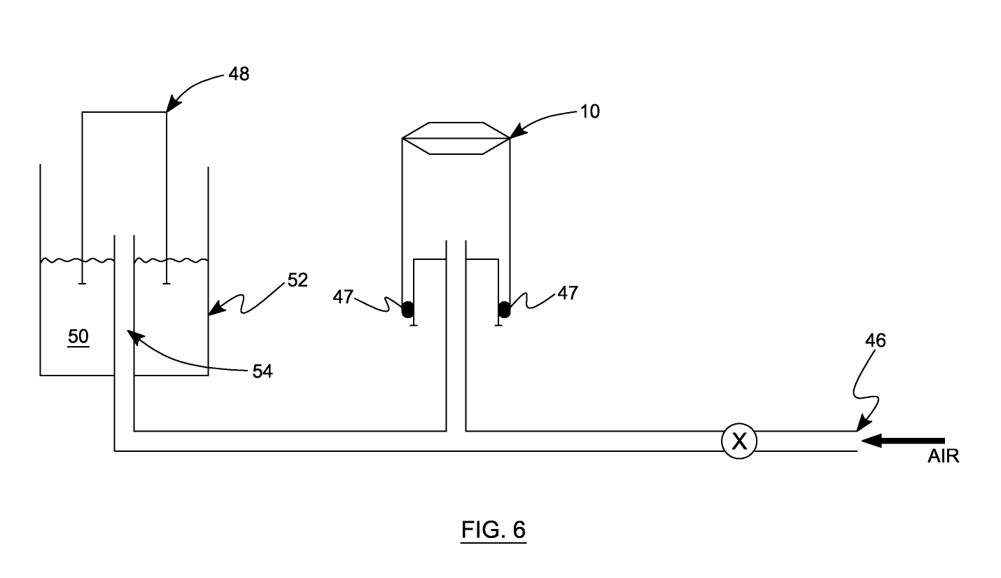

Referring to FIG. 6, an experimental setup was developed to assess the deflating capacity of various bags. In the setup, air enters the system at an inlet 46 and first inflates the bag 10 until it is full. The bag 10 has been sealed to the pipe inlet with a sealing unit 47. Next, the air continues to push through the system and enters the second unit pushing up the weighted upside-down bucket 48 which is forced up to float on the water 50 is a lower vessel 52. The weighted bucket 48 exerted a downward force of about 8.6 lbs for the below experiments. When the weighted bucket 48 reaches a certain predetermined height, the air pressure is shut off and the system is closed, but for the deflatability of the bag. Air exits the bag under force of the weighted bucket which drops downward forcing out the air from its cavity, through the line 54 and toward the bag 10. The descent time of the weighted bucket 48 is measured to evaluate the deflation (time/volume).

Experiments were conducted and the following results were obtained:

| | End | Start | Run | | |
|---|---|---|---|---|---|
| Diameter | 11.375 | 10.9 | 6.250 | | |
| Radius | 5.687 | 5.437 | 6.250 | | |
| Cm | 14.4 | 13.8 | 15.9 | | |
| Surface | 655.6 | 599.2 | 627.4 | 9960 | |
| Volume | | | | 9.960 | Litres |

| | | | Embodiment |
|---|---|---|---|
| | Embodiment | Embodiment | of FIGS. 1-3 of |
| | of present | of present | U.S. pat. No. |
| | invention #1 | invention #2 | 6,986,605 |
| Bag No. | (sec) | (sec) | (sec) |
| 1 | 319 | 159 | 668 |
| 2 | 133 | 133 | >600 |
| 3 | 236 | 138 | >600 |
| 4 | 189 | 177 | >600 |
| 5 | 219 | 123 | 469 |
| | 219 | 146 | 587 |
| cc/sec | 45.4 | 68.2 | 17.0 |

Thus, the deflation rates of the embodiments of the present invention (45.4 and 68.2) are far superior to the deflation rate of the tested prior art bag. Furthermore, it has been seen that once the bags of the present invention are filled with material, sealed and stacked, they deflate in about 15 minutes, which allows users to be able to stack pallets with bags immediately at the exit of the filling machine and to obtain a stable, safe stack. In contrast, the embodiment of U.S. Pat. No. 6,986,605 (“Exopack”), which must deflate via the top or bottom surfaces (see FIGS. 15 and 16 of U.S. '605) has been seen to take about 24 hours to deflate to achieve a stable stack. Thus, the bags of the present invention enable advantageous deflation by providing the vents on the sides rather than on the top and bottom surfaces.

What is claimed is:

1. A multilayer bag having a sealable open end, a closed end, and a tubular wall between the ends defining a cavity for receiving a powder material, the tubular wall being sized and configured to have, once the bag is filled with the powder material and stacked, a first pair of opposed spaced-apart stacking sections which face upward and downward respectively and a second pair of opposed spaced-apart side sections which face laterally in opposite directions; the tubular wall comprising an inner plastic liner with vents sized and configured to be located along at least one of the lateral sections of the second pair to allow stacking pressure to expel air from inside the inner plastic liner through the vents; a first paper layer contiguous with the inner plastic liner; a humidity barrier layer contiguous with the first paper layer and non-adjacent with the inner plastic liner; and at least one outer paper layer outside of the humidity barrier layer.

2. The bag of claim 1, wherein the vents comprise slits.

3. The bag of claim 1, wherein the vents are provided in a pattern for one or each side section, the pattern extending lengthwise along the inner plastic liner from the closed end to the open end.

4. The bag of claim 1, wherein the vents are provided in a pattern for each side section, the pattern extending lengthwise along the inner plastic liner from the closed end to the open end.

5. The bag of claim 4, wherein the pattern of the vents for each lateral section comprises two linear rows and the vents are regularly spaced from each other.

6. The bag of claim 5, wherein the vents are regularly spaced away from each other by between about 2 inches to about 3 inches.

7. The bag of claim 6, wherein each of the vents is sized between about 40 mil and about 60 mil.

8. The bag of claim 7, wherein each side section has a center crease extending lengthwise and the vents are provided spaced away from the crease.

9. The bag of claim 7, wherein the first and second pairs of sections join to form corners and the vents are provided proximate the corners.

10. The bag of claim 1, wherein the liner is attached to the first paper layer with adhesive at the open end.

11. The bag of claim 1, wherein the inner plastic liner is composed of low density polyethylene.

12. The bag of claim 1, wherein the humidity barrier layer is composed of high density polyethylene.

13. The bag of claim 1, wherein the vents are provided along the entire length of the inner plastic liner.

14. The bag of claim 1, wherein the inner plastic liner comprises a non-vented zone at each end of the bag.

15. The bag of claim 1, wherein the inner plastic liner has diagonally sealed corners at the closed end of the bag.

16. The bag of claim 1, having a deflation rate above about 30 cc/sec.

17. The bag of claim 16, having a deflation rate above about 40 cc/sec.

18. The bag of claim 17, having a deflation rate above about 60 cc/sec.

19. A method of stacking a plurality of bags, each bag being filled with the powder material and being defined as per claim 1, comprising the steps of:
laying down a first set of the bags;
laying down a second set of the bags on top of the first set of bags;
allowing sufficient time to elapse such that the first set of the bags deflates under stacking pressure to facilitate stable placement of a third set of bags on top of the second set of bags.
